(19) United States
(12) Patent Application Publication
(10) Pub. No.: US 2009/0188401 A1
(43) Pub. Date: Jul. 30, 2009

(54) Apparatus and Method for Conditioning Dampening Solution for an Offset Printing Press, Dampening System and Offset Printing Press

(75) Inventors: Werner Anweiler, Bruchsal (DE); Martin Dietze, Langen (DE); Uwe Stang, Heidelberg (DE); Roland Thiem, Steinheim An Der Murr (DE)

Correspondence Address: LERNER GREENBERG STEMER LLP, P O BOX 2480, HOLLYWOOD, FL, 33022-2480, US

(73) Assignee: Heidelberger Druckmaschinen Aktiengesellschaft, Heidelberg (DE)

(21) Appl. No.: 12/361,637

(22) Filed: Jan. 29, 2009

(30) Foreign Application Priority Data
Jan. 29, 2008 (DE) 10 2008 006 668.0

(51) Int. Cl. B41L 25/00; B01J 47/00; B01J 47/14

(52) U.S. Cl. 101/147; 210/96.1; 210/251; 210/662

(57) ABSTRACT

An apparatus and a method for conditioning dampening solution for an offset printing press, include a cation exchanger for the removal of salt-forming ions from the dampening solution. The operation of the cation exchanger leaves the pH of the dampening solution unchanged. The apparatus includes a control device based on measuring the water hardness of the dampening solution for the supply of the dampening solution to the cation exchanger. A dampening system and an offset printing press are also provided.

### CROSS-REFERENCE TO RELATED APPLICATION

This application claims the priority, under 35 U.S.C. §119, of German Patent Application DE 10 2008 006 668.0, filed Jan. 29, 2008; the prior application is herewith incorporated by reference in its entirety.

### BACKGROUND OF THE INVENTION

### Field of the Invention

The invention relates to an apparatus and a method for conditioning dampening solution for an offset printing press, having an ion exchanger for the removal of salt-forming ions from the dampening solution. The invention also relates to a dampening system and an offset printing press.

At the present time, it is a matter of concern to reduce or even, if possible, completely avoid the use of polluting substances in an offset printing process. In particular, it is desired to print with reduced alcohol or without alcohol, and in practical terms to reduce the use of isopropanol (IPA) or make it completely unnecessary. In practice, however, in isopropanol-free offset printing, a problem arises which is that frequently, even after only a few weeks, the dampening solution of the offset printing press has to be replaced completely, since the quality of the offset printing process decreases to a great extent. That is acceptable neither from an ecological nor from an economical point of view, since the frequent disposal of dampening solution, as special industrial waste, is expensive and not environmentally friendly. Added thereto are considerable downtimes of the offset printing press during the dampening solution change.

One of the main causes of the problem described is constituted by the contamination of the dampening solution. In order to reduce such contamination in the case of alcohol-free or reduced-alcohol offset printing, filters are used in a dampening solution circuit, so that service times are lengthened. Nevertheless, even after a short time, the printing quality can worsen.

One cause for that phenomenon is water hardness constituents which are concentrated in the dampening solution and which originate predominantly from a paper coating (calcium carbonate, CaCO₃) but can also come from the ink. The calcium carbonate disassociates in the dampening solution into the ions Ca²⁺ and HCO₃⁻, with the Ca²⁺ ions having a critical proportion of the water hardness of the dampening solution. Since normal filters cannot capture or reduce the dissolved ions, the water hardness tends to increase more and more over the course of time, until it reaches a temporary equilibrium state at a high water hardness level. That fact can lead to a printing quality that becomes considerably poorer and even to deposits on the rolls of the offset printing press. Clearly, that process depends highly on the jobs to be printed, more precisely on the materials being used (for example paper, ink, printing unit washing agent, dampening solution additives) and the unprocessed water being used.

In European Patent Application EP 1 577 117 A2, corresponding to U.S. Pat. No. 7,449,108, an apparatus for conditioning dampening solution for offset printing is described. The pH and the electric conductivity of the dampening solution are regulated simultaneously. The dampening solution is filtered and subjected to a magnetic field, in order to break up molecular cohesion leading to the formation of crystals. With regard to the pH control, the dampening solution can be acidified through the use of an ion exchanger. With regard to the electric conductivity control, two specific solutions having a large number of contained substances, which replace the isopropanol widely used in offset printing, are added to the dampening solution.

The technical teaching illustrated in European Patent Application EP 1 577 117 A2, corresponding to U.S. Pat. No. 7,449,108, is complicated and uses special dampening solution additives. In particular, the conductivity of the dampening solution is a controlled variable that is critical in practical use: firstly the conductivity is, in practice, dependent on the print job. The conductivity is also only partly affected by substances influencing the printing process.

### SUMMARY OF THE INVENTION

It is accordingly an object of the invention to provide an apparatus and a method for conditioning dampening solution for an offset printing press, a dampening system and an offset printing press, which overcome the hereinafore-mentioned disadvantages of the heretofore-known apparatuses and methods of this general type and which make the longest possible service life of dampening solution possible in a straightforward manner.

With the foregoing and other objects in view there is provided, in accordance with the invention, an apparatus for conditioning dampening solution for an offset printing press. The apparatus comprises an ion exchanger for removal of salt-forming ions, in particular salt-precipitating ions, from the dampening solution. The ion exchanger is a cation exchanger leaving a pH of the dampening solution unchanged during operation of the cation exchanger. A control device based on measuring a water hardness of the dampening solution supplies the dampening solution to the cation exchanger.

Advantageously, by using the invention, the water hardness of the dampening solution can be regulated or monitored and set. Through the use of the invention, the dampening solution conditioning is improved and a longer service life of the dampening solution can be achieved with a high printing quality.

The dampening solution can, in particular, be a reduced-alcohol or alcohol-free dampening solution, for example a dampening solution having a content of isopropanol which is reduced or which is free of isopropanol. One important solvent component of the dampening solution is water. The offset printing press can, in particular, be a sheetfed offset printing press. The pH can remain substantially unchanged.

In relation to the water hardness, it should be noted at this point that the total hardness indicates the total of the concentrations of the cations of alkaline earth metals in water. In the Si measurement system, the content of alkaline earth ions is specified in mol per liter. In practice, the water hardness is commonly also quantified in degrees of German hardness (° dH). In this case, 1° dH is defined as 10 mg CaO in each liter of water. Equivalent quantities are defined for the other hardness constituents: for magnesium, the equivalent quantity is approximately 7.19 mg of MgO per liter of water. 1° dH is 0.1783 mmol/l or 17.8 ppm CaCO₃.

In accordance with another feature of the invention, the cation exchanger is able to replace doubly charged cations by singly charged cations. In other words, doubly charged cations, in particular alkaline earth metal ions, can be picked up from the dampening solution in the cation exchanger and singly charged cations, in particular alkali metal ions, can be output to the dampening solution. In practical terms, the cation exchanger can replace Ca²⁺ ions and/or Mg²⁺ ions with Na⁺ ions. In this way, an excessively high water hardness of the dampening solution can be reduced, which in turn improves the printing quality and increases the service life of the dampening solution considerably.

In accordance with a further feature of the invention, in various embodiments, the apparatus according to the invention for conditioning dampening solution includes an ion-selective electrode for Ca²⁺ ions and/or Mg²⁺ ions or a titration device for Ca²⁺ ions and/or Mg²⁺ ions or a water hardness sensor for the water hardness measurement. The titration device can, in particular, be automatic. One practical measurement of water hardness is complexometric titration with an aqueous solution of a disodium salt of ethylenediamine tetraacetic acid (EDTA), which forms soluble and stable chelate complexes with Ca²⁺ ions and/or Mg²⁺ ions.

In accordance with an added feature of the invention, in an advantageous development, the apparatus according to the invention for conditioning dampening solution includes a device for the controlled addition of pH buffer solution into the dampening solution, having a control system and a measuring device connected to the control system for determining the pH of the dampening solution.

In accordance with an additional feature of the invention, furthermore or as an alternative to other features described, the apparatus for conditioning dampening solution can have at least one filter for separating out contaminants in the dampening solution. In particular, the filter can include a coarse filter, a fine filter and/or an oil filter.

Other dampening solution filters, such as membrane filters, centrifuges or granular/loose fill filters, can also be used. The filters can also be connected independently of the cation exchanger, such as in a bypass, in forcible circulation or in an intermediate tank.

In accordance with yet another feature of the invention, furthermore or as an alternative to other features described, the supply of dampening solution to the cation exchanger and/or to the filter can be interruptible and/or operable independently of each other.

In accordance with yet a further feature of the invention, furthermore or as an alternative to other features described, the apparatus according to the invention for conditioning dampening solution can have an anion exchanger for the output of OH⁻ ions.

With the objects of the invention in view, there is also provided a dampening solution system for an offset printing press having a printing unit. The dampening solution system comprises at least one dampening solution reservoir, a feed line from the dampening solution reservoir to the printing unit, a return line from the printing unit to the dampening solution reservoir, and at least one apparatus for conditioning dampening solution according to the invention.

In accordance with another feature of the invention, in particular, in the dampening solution system according to the invention, the water hardness measurement can be carried out in the dampening solution reservoir. Furthermore or as an alternative to other features described, the cation exchanger of the dampening solution system can be located in a bypass circuit for the dampening solution. In this case, in particular the bypass circuit can also include valves and/or one or more devices for volume flow measurement.

In a possible development, an apparatus according to the invention for conditioning dampening solution and having a cation exchanger can be connected to the dampening solution circuit of a plurality of offset printing presses. In other words, the apparatus according to the invention can be constructed in such a way that the dampening solution from a plurality of offset printing presses can be conditioned.

With the objects of the invention in view, there is additionally provided an offset printing press, in particular a sheetfed offset printing press. The offset printing press according to the invention includes at least one dampening solution system having features or feature combinations according to the invention. The printing material processed in the offset printing press can, in particular, be paper, paperboard or cardboard.

With the objects of the invention in view, there is furthermore provided a method for conditioning dampening solution for an offset printing press. The method comprises supplying dampening solution to an ion exchanger for removal of salt-forming ions, in particular salt-precipitating ions, from the dampening solution, controlling the supply of the dampening solution to the ion exchanger as a function of a measured water hardness of the dampening solution, and exchanging cations in the ion exchanger while maintaining a pH of the dampening solution substantially unchanged.

In accordance with another mode of the invention, the cation exchanger can, in particular, be supplied with a volume of dampening solution which is determined as a function of the measured water hardness before the cation exchange and a desired water hardness set point after the cation exchange.

In accordance with a further mode of the invention, in the method according to the invention for conditioning dampening solution for an offset printing press, in particular use can be made of a dampening solution system having features or feature combinations according to the invention.

In accordance with an added mode of the invention, in a preferred embodiment of the method according to the invention for conditioning dampening solution, the dampening solution includes a dampening solution additive which contains a buffer system that sets the pH of the dampening solution between 4.0 and 7.0, preferably between 4.5 and 5.0.

In accordance with an additional mode of the invention, the dampening solution can have a dampening solution additive which contains a buffer system that is composed of organic or inorganic acids and their corresponding salts.

In accordance with yet another mode of the invention, in the method according to the invention for conditioning dampening solution, it is particularly preferred for the buffer system to be composed of a dicarboxylic acid or a tricarboxylic acid and also one or more of their alkali salts.

In accordance with yet a further mode of the invention, as an alternative to this or in addition, the dampening solution additive can include a polymer from the group including modified celluloses, dextrins, polyethylene glycols, modified polyethyleneimines and polypropylene glycols.

In accordance with a concomitant mode of the invention, it is particularly preferred for the method according to the invention for conditioning dampening solution to be used for low-alcohol or alcohol-free dampening solution.

Other features which are considered as characteristic for the invention are set forth in the appended claims.

Although the invention is illustrated and described herein as embodied in an apparatus and a method for conditioning dampening solution for an offset printing press, a dampening system and an offset printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DETAILED DESCRIPTION OF THE SEVERAL VIEWS OF THE DRAWING

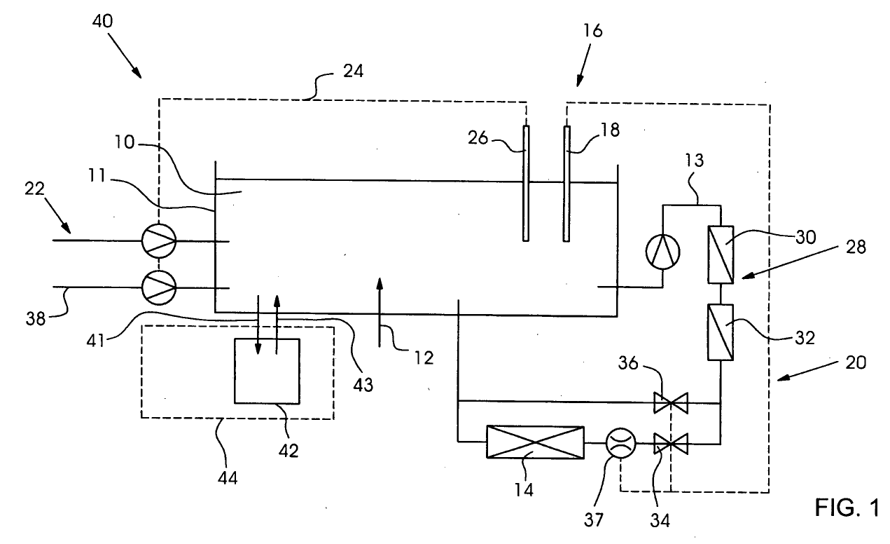

FIG. 1 is a schematic and block diagram of a preferred embodiment of the apparatus according to the invention for conditioning dampening solution, suitable for isopropanol-free or reduced-isopropanol offset printing; and

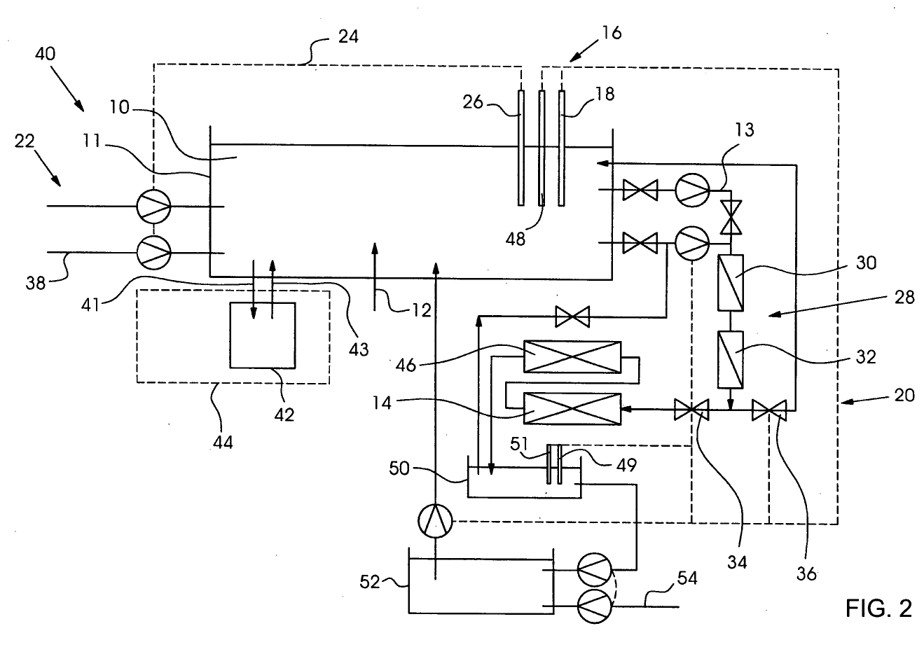

FIG. 2 is a schematic and block diagram of an alternative embodiment of the apparatus according to the invention for conditioning dampening solution, with a further development of an additional anion exchanger.

### DETAILED DESCRIPTION OF THE INVENTION

Referring now to the figures of the drawings in detail and first, particularly, to FIG. 1 thereof, there is seen a preferred embodiment of an apparatus according to the invention for conditioning dampening solution 10, suitable for isopropanol-free or reduced-isopropanol offset printing. An offset printing press 44 includes a printing unit 42. A dampening solution system 40 interacts with the printing unit 42. The dampening solution 10 can pass from a dampening solution reservoir 11 of the dampening solution system 40 through a feed line 41 to the printing unit 42 and back from the printing unit 42 to the dampening solution reservoir 11 through a return line 43. In general, the dampening solution reservoir 11 is supplied with hardened fresh water or unprocessed water and common dampening solution additives through a filling feed 38 that can be shut off through the use of a valve. The dampening solution 10 being supplied is intended to have a hardness value of 8° to 16° dH (German hardness), preferably 8° to 12° dH in the case of a water hardness measurement 16 through the use of titration of Ca²⁺ and Mg²⁺ ions or through the use of a water hardness sensor. In the case of a Ca²⁺ ion measurement through the use of an ion-sensitive electrode 18, the hardness value should rather be around 8° dH, for example the hardening should be carried out to 4° dH Mg²⁺ and 4° dH Ca²⁺.

In FIG. 1, a control loop according to the invention (control device 20) for the water hardness of the dampening solution 10 is shown: automatic and precise measurement 16 of the water hardness is an ambitious undertaking. In the schematically illustrated embodiment, an ion-selective electrode 18 is used to measure the Ca²⁺ ions. A first valve 34, which regulates a flow rate to a cation exchanger 14, is activated. Depending on the change in the water hardness of the dampening solution 10, an input of hardness 12 into the dampening solution, continuous or discontinuous operation of the cation exchanger 14 is possible and is carried out as required, depending on the measured water hardness values.

It should be noted at this point that the measurement 16 of the water hardness with alternative measuring devices, not illustrated in FIG. 1, has an advantage as compared with a pure Ca²⁺ measurement which is that, in addition to the Ca²⁺ ions, the Mg²⁺ ions predominantly introduced by the hardened fresh water or unprocessed water (filling feed 38) are also measured.

In the embodiment shown in FIG. 1, the cation exchanger 14 is in a bypass circuit 13, which can be regulated and switched off through the use of a valve, behind a dampening solution filter combination (filter 28 with coarse filter 30 and fine filter 32, into which an oil filter is integrated in this embodiment), which reduces the input of contaminants into the cation exchanger 14. The flow of the dampening solution 10 to the cation exchanger 14 can also be activated or regulated by the first valve 34 and a second valve 36 in such a way that none or only a partial stream or only a specific volume of the filtered dampening solution 10 flows through the cation exchanger 14, so that the quantity of Ca²⁺ ions removed can be monitored.

The dampening solution volume flow and/or the dampening solution volume, which flows through the cation exchanger, can be determined through the use of a volume flow measurement 37. In this way, the dampening solution supply to the cation exchanger can be activated or regulated.

In the event of a very high input of hardness 12 of water hardness constituent ions into the dampening solution 10, the pH of the dampening solution 10 can rise, in particular as a result of hydrogen carbonate ions (CaCO₃⁻ ions) that cannot be removed by the cation exchanger 14, and can depart from the pH range of from about 4.5 to 5.5 which is optimal for printing. In order to prevent that, the pH of the dampening solution is additionally monitored (control system 24 for pH buffer solution) in the embodiment shown. For the purpose of measurement, a pH sensor (measuring device 26 for pH) is employed. The pH of the dampening solution 10 can be brought into the stated range once more due to the addition of a pH buffer solution through the use of a device 22, which can be regulated by a valve. As an alternative to the pH regulation shown through the use of pH buffer solution, if appropriate the percentage quantity of a dampening solution additive having buffer substances can also be increased.

In order to achieve a good printing quality, the water hardness in the dampening solution 10 should be at most 20° dH, preferably approximately in a range of from 8 to 16° dH, preferably 8 to 12° dH for Ca²⁺ ions. If all of the water hardness constituent ions are removed from the dampening solution 10, the water becomes too soft and the printing quality decreases again. For this reason, the water hardness is preferably regulated in the specified range.

Practical control in the control loop (control device 20) of the embodiment shown in FIG. 1, having a water hardness measurement in the dampening solution tank or dampening solution reservoir 11, can be such that the water hardness is measured repeatedly all day long. The cation exchanger 14 is activated only if a limit of about 14 to 16° dH for the water hardness is exceeded. The cation exchanger 14 is switched on as a function of presettings and characteristic curves, which control the control valves (first valve 34 and second valve 36) and therefore determine the quantity of dampening solution flowing through. As a result, the water hardness is reduced slowly again until it has reached a value of about 8° dH to 12° dH. The control described and the action on the dampening solution can also be carried out during a running printing process. During the reduction phase of the water hardness with the cation exchanger running, the frequency of water hardness measurements is increased, for example every 10 minutes, in order to be able to terminate the cation exchange in good time when the lower water hardness limiting value is reached. Once the water hardness is in the desired range again, the cation exchanger can be switched off again. The water hardness monitoring can once more be carried out repeatedly during the day. The cation exchanger will only be automatically activated again if the upper limiting value is exceeded again.

Further practical control in the control loop (control device 20) of the embodiment shown in FIG. 1, having a water hardness measurement in the dampening solution tank or dampening solution reservoir 11, can be such that the water hardness is measured repeatedly during the day. The cation exchanger 14 will only be activated when a limit of about 14 to 16° dH for the water hardness is exceeded.

The dampening solution volume, which is intended to flow through the cation exchanger, is determined depending on the measured water hardness (for example 20° dH) and the preferred set point of the water hardness (for example 10° dH). If the predefined dampening solution volume, which was determined through the use of the volume flow measurement 37, has flowed through the cation exchanger 14, the cation exchanger 14 is deactivated again and the water hardness is then measured.

If, on one hand, the water hardness is in the desired range again or is too low, the cation exchanger 14 remains switched off and the water hardness monitoring is again carried out repeatedly during the day.

If, on the other hand, the water hardness is still too high, depending on the measured new water hardness values, a new dampening solution volume which is to flow through the cation exchanger is determined. The process is repeated until the desired water hardness is reached and therefore the normal water hardness monitoring is carried out once more.

The regeneration of the cation exchanger 14 can be carried out through the use of a salt solution (NaCl solution). In particular, the regeneration can be automated.

The cation exchanger 14 should be employed in combination with the filters 28 in order to clean the dampening solution 10 first, before it passes into the cation exchanger 14. Through the use of filtration, fats, oils, ink constituents, paper fibers, calcium carbonate and paper coating should be removed from the dampening solution 10, in order to protect the cation exchanger 14 against contamination.

Specific filters can also be employed instead of commercially available filters. For instance, membrane filters (for example ultrafiltration) or centrifuges can be used. They have a very good filtration action. A particular advantage of these filters, which are currently still relatively costly, resides in the fact that the as yet undissolved calcium carbonate can be removed substantially completely from the entire filter circuit, which means that the formation of Ca²⁺ ions from the solid material is reduced definitively.

FIG. 2 represents an alternative embodiment of the apparatus according to the invention for conditioning dampening solution 10, with the further development of an additional anion exchanger 46. Optionally, a conductivity measurement 48 is also provided (with the aim of limiting a conductivity range), for the control device 20 in the alternative embodiment. Beyond the features already described with reference to FIG. 1 and identified by the same designations, in this alternative embodiment, the anion exchanger 46 for the removal of salt-forming anions from the dampening solution 10 and for the output of OH⁻ ions into the dampening solution 10 is disposed downstream of the cation exchanger 14 in the bypass circuit 13. An intermediate tank 50, which is disposed downstream of the anion exchanger 46 in the bypass circuit 13, is regulated to a neutral pH (pH=7) through the use of a second pH measurement 49 and/or a second conductivity measurement 51. The dampening solution 10, deionized in this way, passes into a mixing tank 52 in which, through the use of the metered addition of common dampening solution additive (metering feed 54 with valve), in particular including a pH buffer substance, ions and a water hardness constituent, it is brought to a pH of 4.5 to 5.5. The metering of the dampening solution additive is carried out as a function of the quantity of dampening solution fed from the intermediate tank 50 to the mixing tank 52 and controllable through the use of a valve. The hardened dampening solution 10 passes from the mixing tank 52 into the dampening solution reservoir 11 again, with it being possible for the supply to be regulated by activating a valve through the control device 20.

1. An apparatus for conditioning dampening solution for an offset printing press, the apparatus comprising:
an ion exchanger for removal of salt-forming ions from the dampening solution, said ion exchanger being a cation exchanger leaving a pH of the dampening solution unchanged during operation of said cation exchanger; and
a control device for supplying the dampening solution to said cation exchanger based on measuring a water hardness of the dampening solution.

2. The apparatus for conditioning dampening solution according to claim 1, wherein said cation exchanger replaces doubly charged cations with singly charged cations.

3. The apparatus for conditioning dampening solution according to claim 2, wherein said cation exchanger replaces at least one of Ca²⁺ ions or Mg²⁺ ions with Na⁺ ions.

4. The apparatus for conditioning dampening solution according to claim 1, which further comprises an ion-selective electrode for at least one of Ca²⁺ ions or Mg²⁺ ions or a titration device for at least one of Ca²⁺ ions or Mg²⁺ ions or a water hardness sensor for the water hardness measurement.

5. The apparatus for conditioning dampening solution according to claim 1, which further comprises a device for controlled addition of pH buffer solution into the dampening solution, a control system, and a measuring device connected to said control system for determining the pH of the dampening solution.

6. The apparatus for conditioning dampening solution according to claim 1, which further comprises at least one filter for separating out contaminants in the dampening solution.

7. The apparatus for conditioning dampening solution according to claim 6, wherein said at least one filter includes at least one of a coarse filter, a fine filter or an oil filter.

8. The apparatus for conditioning dampening solution according to claim 6, wherein a supply of dampening solution to at least one of said cation exchanger or said filter is at least one of interruptible or operable independently of each other.

9. The apparatus for conditioning dampening solution according to claim 1, which further comprises an anion exchanger for an output of OH⁻ ions.

10. A dampening solution system for an offset printing press having a printing unit, the dampening solution system comprising:
at least one dampening solution reservoir;
a feed line from said dampening solution reservoir to the printing unit;
a return line from the printing unit to said dampening solution reservoir; and
at least one apparatus for conditioning dampening solution according to claim 1.

11. The dampening solution system according to claim 10, wherein the water hardness measurement is carried out in said dampening solution reservoir.

12. The dampening solution system according to claim 10, which further comprises a bypass circuit for the dampening solution, said cation exchanger being located in said bypass circuit.

13. The dampening solution system according to claim 12, wherein said bypass circuit includes at least one of valves or one or more devices for volume flow measurement.

14. An offset printing press, comprising:
a printing unit; and
a dampening solution system including:
at least one dampening solution reservoir;
a feed line from said dampening solution reservoir to said printing unit;
a return line from said printing unit to said dampening solution reservoir; and
at least one apparatus for conditioning dampening solution according to claim 1.

15. A method for conditioning dampening solution for an offset printing press, the method comprising the following steps:
supplying dampening solution to a cation exchanger for removal of salt-forming ions from the dampening solution;
controlling the supply of the dampening solution to the cation exchanger as a function of a measured water hardness of the dampening solution; and
exchanging cations in the cation exchanger while maintaining a pH of the dampening solution substantially unchanged.

16. The method for conditioning dampening solution for an offset printing press according to claim 15, which further comprises supplying the cation exchanger with a volume of dampening solution determined as a function of the measured water hardness before the cation exchange and a desired water hardness set point after the cation exchange.

17. The method for conditioning dampening solution for an offset printing press according to claim 15, which further comprises providing a dampening solution system including at least one dampening solution reservoir, a feed line from the dampening solution reservoir to a printing unit of the offset printing press, a return line from the printing unit to the dampening solution reservoir, and at least one apparatus for conditioning dampening solution according to claim 1.

18. The method for conditioning dampening solution for an offset printing press according to claim 15, which further comprises providing the dampening solution with a dampening solution additive containing a buffer system setting a pH of the dampening solution to between 4.0 and 7.0.

19. The method for conditioning dampening solution for an offset printing press according to claim 15, which further comprises providing the dampening solution with a dampening solution additive containing a buffer system composed of organic or inorganic acids and their corresponding salts.

20. The method for conditioning dampening solution for an offset printing press according to claim 18, wherein the buffer system is composed of a dicarboxylic acid or a tricarboxylic acid and one or more of their alkali salts.

21. The method for conditioning dampening solution for an offset printing press according to claim 19, wherein the buffer system is composed of a dicarboxylic acid or a tricarboxylic acid and one or more of their alkali salts.

22. The method for conditioning dampening solution for an offset printing press according to claim 18, wherein the dampening solution additive includes a polymer selected from the group consisting of modified celluloses, dextrins, polyethylene glycols, modified polyethyleneimines and polypropylene glycols.

23. The method for conditioning dampening solution for an offset printing press according to claim 19, wherein the dampening solution additive includes a polymer selected from the group consisting of modified celluloses, dextrins, polyethylene glycols, modified polyethyleneimines and polypropylene glycols.

24. The method for conditioning dampening solution for an offset printing press according to claim 15, wherein the dampening solution is a low-alcohol or alcohol-free dampening solution.
